(19) United States
(12) Patent Application Publication
(10) Pub. No.: US 2011/0168270 A1
(43) Pub. Date: Jul. 14, 2011

(54) EXTENDED RANGE FLUID FLOW RESISTOR

(75) Inventors: Jeffrey A. Carlisle, Stratham, NH (US); Benjamin G. Powers, Portsmouth, NH (US)

(73) Assignee: FLUIDNET CORPORATION, Amesbury, MA (US)

(21) Appl. No.: 13/063,660

(22) PCT Filed: Dec. 17, 2009
(86) PCT No.: PCT/US09/68349

§ 371 Date: Mar. 11, 2011

Related U.S. Application Data
(60) Provisional application No. 61/138,690, filed on Dec. 18, 2008.

(51) Int. Cl. F15D 1/00

(52) U.S. Cl. 137/1; 137/561 R; 137/553

(57) ABSTRACT

In one aspect, an extended range fluid flow resistor includes a housing having an inlet and an outlet and defining a fluid passageway therebetween A plunger is slidably received within the fluid passageway and an actuator is rotatably coupled to the housing and the plunger, such that rotation of the actuator causes sliding movement of the plunger within the fluid passageway The plunger has a sealing region and a variable flow region axially adjacent the sealing region Fluid flow through the fluid passageway is prevented when the sealing region is aligned with the inlet and fluid flow through the fluid passageway is permitted when the variable flow region is aligned with the inlet The variable flow region includes a helical groove extending from a first end of the variable flow region adjacent the sealing region and away from the sealing region to a second end of the vanable flow region.

### CROSS-REFERENCE TO RELATED APPLICATIONS

This application claims the priority benefit under 35 U.S.C. §119(e) of U.S. provisional patent application No. 61/138,690 filed Dec. 18, 2008. The aforementioned application is incorporated herein by reference in its entirety.

### BACKGROUND

The present disclosure relates to flow control systems and, more particularly, to a flow resistor assembly for a fluid flow control system, such as a flow control system for an intravenous (IV) infusion pump. While the flow resistor assembly herein may be adapted for use with all manner of flow control systems, it may advantageously be used in connection with feedback control infusion pumps, such as those disclosed in International Application No. PCT/US2007/002039 filed Jan. 23, 2007, International Application No. PCT/US2007/004945 filed Feb. 27, 2007, and International Application No. PCT/US2007/005095 filed Feb. 27, 2007, which are commonly owned herewith. Each of the aforementioned patent applications is incorporated herein by reference in its entirety.

Conventional flow resistors do not offer a stable and adjustable resistance over the required flow rate range for IV therapy. Conventional resistors, such as needle valves, generally use mechanical, face-to-face collisions as the means to shut off the infusion pump and, as a result, have difficulty controlling low flow rates.

An ideal embodiment of a flow resistor would be one with continuous flow, wide flow rate range, wide range of viscosity compatibility, wide range of density compatibility, wide range of biocompatibility, suitability for long term use, low cost, simplicity, intuitive operation, automated information exchange, safety, and reliability.

The present disclosure contemplates a new and improved fluid flow resistor that operates over a wide range of fluid flow rates for fluids of varying viscosities and densities.

### SUMMARY

In one aspect, the present disclosure provides an extended range fluid flow resistor for a fluid flow control system comprising an outer housing, an adjustment cap and a movable plunger. The outer housing comprises an interior passageway with an axially extending channel and a fluid inlet and outlet. The movable plunger comprises a screw interface region, a variable spiral region, a sealing region, and an interior fluid pathway. The adjustment cap comprises a body, a screw interface region, a distal seal and one or more interior protrusions. The adjustment cap is rotatably coupled to the outer housing enabling the cap to be rotated about the housing. The movable plunger is moveably secured within the interior passageway of the outer housing and includes a screw interface, which interacts with the screw interface of the adjustment cap. As the adjustment cap is rotated, the movable plunger translates linearly through the interior passageway of the outer housing. As the movable plunger translates through the interior passageway, a portion of a variable spiral flow path, located in the variable spiral region, interacts with the fluid inlet and enables fluid to travel through the fluid flow resistor and out the fluid outlet at the desired fluid flow rate. The spiral flow path contains a channel with a variable width and/or depth over its path creating a wide range of fluid flow rates. In exemplary, non-limiting embodiments, the fluid flow resistor can provide flow rates from 0.1 mL/hr to 6,000 mL/hr.

In another aspect, a method for controlling the fluid flow rate using an extended range fluid flow resistor is provided. Infusion data is input, e.g., via an electronic control board, and instructions based on the input data are output to control a resistor adjustment motor. The position of an inline flow object is monitored as IV fluid travels from the fluid inlet through the flow resistor and out via the fluid outlet. The position of the inline flow object varies as a function of the flow rate and the position of the flow object may be monitored optically, e.g., using an LED array or other light source and an optical detector. By monitoring the position of the inline flow object, the extended range flow resistor is adjusted with the adjustment motor until a target flow rate is achieved.

In yet another aspect, a flow control system employing the extended range flow resistor herein is provided.

### BRIEF DESCRIPTION OF THE DRAWINGS

The invention may take form in various components and arrangements of components, and in various steps and arrangements of steps. The drawings are only for purposes of illustrating preferred embodiments and are not to be construed as limiting the invention.

FIG. 1 is a top view of an exemplary extended range fluid flow resistor.

FIG. 2 is a side view of the exemplary extended range fluid flow resistor appearing in FIG. 1.

FIG. 3 is a cross-sectional view taken along the lines 3-3 appearing in FIG. 2.

FIG. 4 is a side view of an exemplary spiral fluid flow resistor assembly.

FIG. 5 is an isometric view illustrating an exemplary adjustment cap.

FIG. 6 is a functional block diagram of a flow resistor assembly and control circuit operable to embody an exemplary embodiment of the present disclosure.

### DETAILED DESCRIPTION OF THE PREFERRED EMBODIMENTS

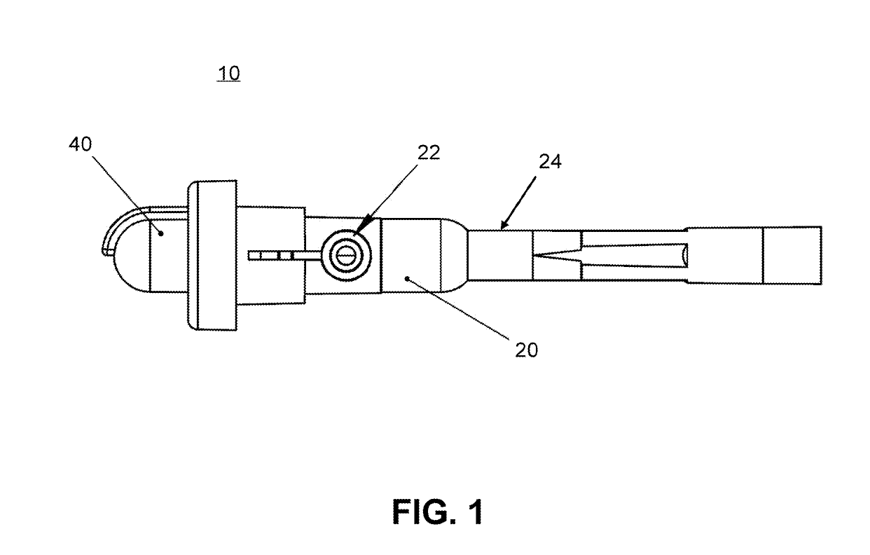

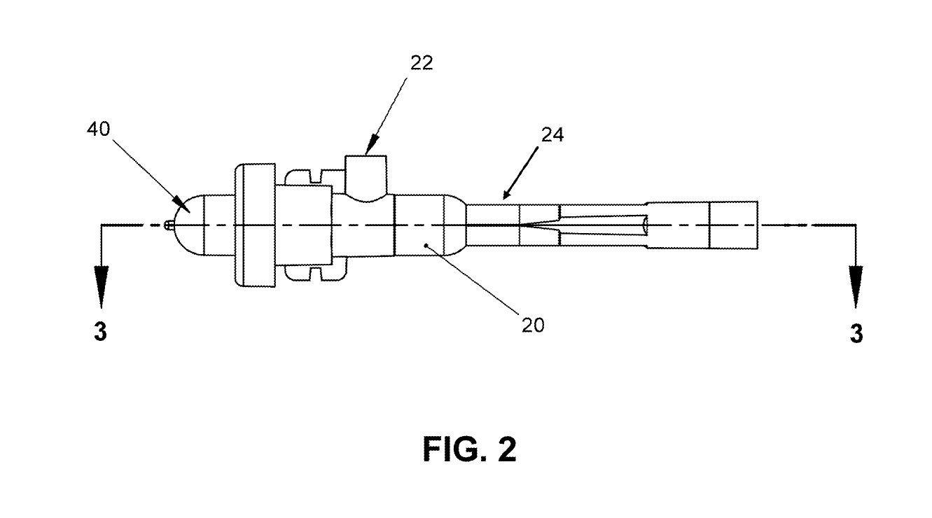

Referring to the drawings, wherein like reference numerals are used to indicate like or analogous components throughout the several views, and with particular reference to FIGS. 1-3, there appears an extended range fluid flow resistor 10 in accordance with an exemplary embodiment of the present disclosure. The fluid flow resistor assembly 10 includes a fixed outer housing 20, an adjustment cap 40, and a movable plunger 60.

The fixed outer housing 20 contains a fluid inlet 22 and a fluid outlet 24. The fluid inlet 22 is fluidically coupled to a fluid source (not shown), e.g., an IV fluid source coupled to the inlet 22 via a fluid inlet tube. The fluid outlet 24 may be fluidically coupled to the vasculature of a patient, e.g., via an IV catheter or cannula (not shown), as generally known in the art. The outer housing 20 is coupled at a rotational interface to the adjustment cap 40 to enable the adjustment cap 40 to rotate about the fixed outer housing 20. The outer housing 20 also contains an interior passageway 26 slidably receiving the movable plunger 60.

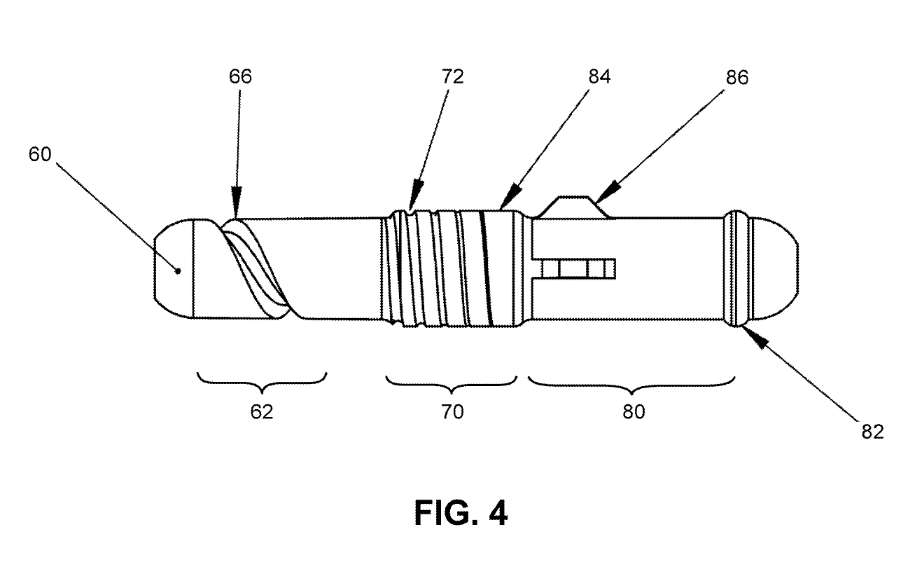

Referring now to FIG. 4 and with continued reference to FIGS. 1-3, the movable plunger 60 of the flow resistor assembly 10 is located within the passageway 26 of the outer housing 20. The movable plunger 60 includes a screw interface region 62 having a helical groove 66, a variable spiral region 70, a sealing region 80 including a proximal seal 82 and a distal seal 84 defining a fluid containing section therebetween, and an interior fluid pathway 64. The adjustment cap 40 includes a body 42, an internal helical protrusion 44, and a distal seal 46. One or more protrusions 48 extend inwardly from the body 42 to connect the cap 40 to the housing 20.

The movable plunger 60 rotatably engages the adjustment cap 40 at the screw interface region 62. The screw interface region 62 consists of the external helical thread 66 on the plunger 60 and the complimentary internal helical thread 44 in the adjustment cap 40. In the depicted embodiment, the external thread 66 is a groove and the internal thread 44 is a complimentary protrusion. In alternative embodiments, the external thread 66 could be a helical protrusion and the internal thread 44 could be a helical groove. The internal helical thread 44 is configured to allow fluid to flow there past, as described below.

In the illustrated embodiment, the internal helical thread 44 rotatably engages the external helical thread 66. Rotation of the cap 40 causes the plunger 60 to be selectively advanced or retracted linearly with respect to the cap 40, depending on the direction of rotation. The linear translation of plunger 60 along the axis of outer housing 20 enables control of the fluid flow rate. When the desired fluid flow rate has been reached, the mechanical stability of the adjustment cap 40 and the plunger 60 enables the adjustment cap 40 to stay in the selected position without requiring additional energy to maintain that position.

The pitch of the screw interface region 62 between the plunger 60 and the cap 40 can be selected to achieve a desired correspondence between the degree of rotation by the cap 40 and the distance moved by the plunger 60 as the cap 40 is rotated between its fully closed position and its fully open position. As the plunger 60 moves from a closed position to an open position, the flow resistance decreases and the flow rate increases. Likewise, as the plunger 60 moves from an open position toward the closed position, the flow resistance increases and the flow rate decreases. Fluid flow is stopped when the plunger 60 is moved to the fully closed position.

In a preferred embodiment, the adjustment cap 40 will have 300 degrees of rotation to move the plunger 42 through its entire path from the closed position to the fully open position. When the degree of rotation is less than 360 degrees (e.g., as determined by the helical twist of the screw interface region 62), mechanical stops (not shown) can be inserted between the adjustment cap 40 and the plunger 60, thereby preventing any additional rotation of the cap 40 and in turn preventing a mechanical collision of the plunger 60 and the cap 40. In addition, when the degree of rotation of the adjustment cap 40 is set below one rotation, the resistor valve (not shown) can be mechanically keyed to a control mechanism (not shown), to prevent the loading or unloading of the resistor valve from the control mechanism in any position other than the closed position. This ensures that the resistor valve is always in the “off” position when removed from the flow control system and prevents any free flowing condition from occurring.

The variable spiral region 70 provides a spiral flow path 72 for the fluid as it enters the fluid inlet 22. The spiral flow path 72 is a helical channel, which has an increasing cross-sectioned area along its length, e.g., which is tapered in terms of width and/or depth and, preferably, has a tapering width and depth. In a closed position, the variable spiral region 70 is not exposed to the fluid inlet 22, thereby preventing fluid flow through the interior of the plunger 60. However, as the cap 40 is rotated, the movable plunger 60 is moved linearly along the interior axis of the housing 20 and exposes a differing portion of the spiral flow path 72 to the fluid entering via the fluid inlet 22. The distal end (relative to the spiral interface region 62) of the spiral region 70 contains the portion of the spiral flow path 72 with the smallest width and/or depth enabling the flow resistor 10 to control relatively low fluid flow rates. The proximal end (left end in the orientation depicted in FIG. 4) of the spiral region 70 contains the portion of the spiral flow path 72 with the largest width and/or depth enabling the flow resistor assembly 10 to control relatively high fluid flow rates.

In the depicted preferred embodiment, the channel 72 gradually increases in width and depth from the smallest size to the largest size as it travels from the distal end to the proximal end of the spiral region 70, providing the wide range of fluid flow rates necessary for IV therapy. In the preferred embodiment, the resistor assembly 10 can operate at flow rates varying over five orders of magnitude, e.g., from about 0.1 mL/hr to about 6,000 mL/hr. In the preferred embodiment, the relationship between flow resistance and plunger translation is fundamentally logarithmic. However, it will be recognized that the profile of the spiral flow path 72 can be tailored to achieve virtually any monotonic profile of flow resistance versus plunger translation, providing an infinite number of possible flow rate ranges.

When the fluid resistor assembly 10 is in an open position, the IV fluid enters the resistor assembly 10 via the fluid inlet 22. The fluid then travels through the open or exposed portion of the channel 72 into the interior space defined between the interior diameter of the cap 40 and the outer diameter of the plunger 60. The fluid travels around the plunger 60 and into an inlet end 65 of the interior pathway 64 of the plunger 60. The interior diameter of the cap 40 and the outer diameter of the plunger 60 are such that a sufficient clearance is provided to allow fluid to pass from the inlet 22 to the plunger inlet end 65. The fluid passes out the outlet end 67 of the plunger 60 into the passageway 26 and exits the resistor outlet 24.

In the depicted embodiment, the fluid passes from the resistor outlet 24 into an integral flow sensor portion 69 including a flow object 120 whose position in an interior flow passageway 125 varies as a function of flow rate. The flow sensor 69 includes a light source 122 and an optical position detector 124 for optically detecting the position of the flow object 120.

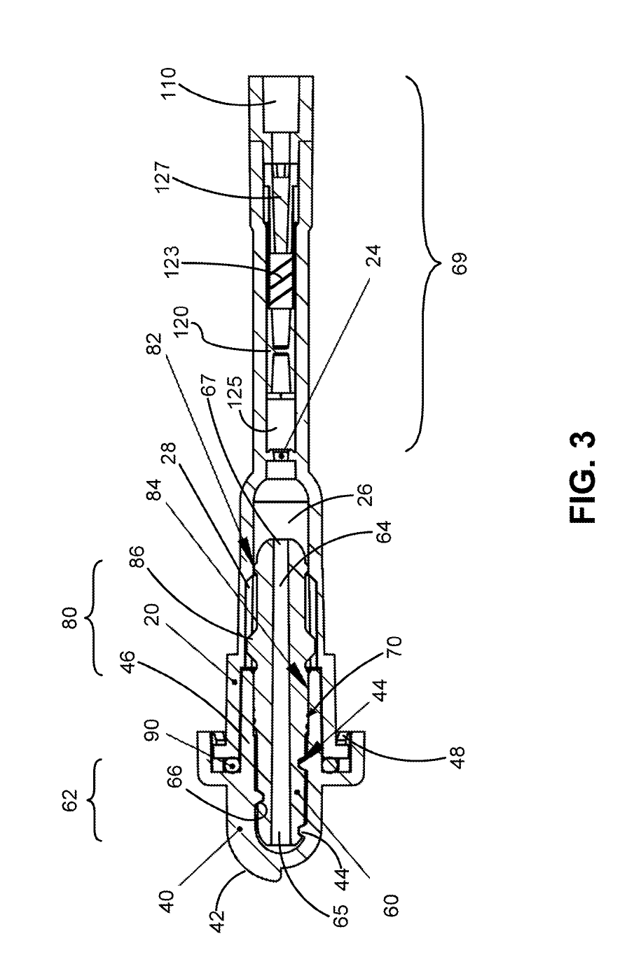

In the depicted embodiment, as best seen in FIG. 3, the flow object 120 is a cylinder having a generally “H” shaped cross-sectional shape although, other configurations are contemplated, including without limitation a ball-shaped flow object. A spring, such as a coil spring 123 or other resilient spring member is seated within the interior passageway 125 of the flow sensor portion 69. The spring 123 urges the flow object 120 in a direction opposite to the direction of fluid flow, with the position of the flow object 120 varying as a function of the flow rate, with higher flow rates causing greater displacement of the flow object against the urging of the spring 123. The interior passageway 125 of the flow sensor portion 69 is generally conical or tapered, opening toward the outlet end 110. In this manner, the annular gap between the flow object 120 and the passageway 125 increases as the flow rate increases. In the depicted preferred embodiment, a spring seat 127 is provided to engage the flow object 120 at very high flow rates, thereby providing an upper limit to the range of axial movement of the flow object 120 within the flow passageway 125.

In alternative embodiments, the flow resistor and flow sensor portions may be separately formed and fluidically coupled. The flow sensor may be of the type described in International Application No. PCT/US2007/002039 filed Jan. 23, 2007, which has entered the National Stage in the U.S. as Ser. No. 12/280,869 filed Aug. 27, 2008, International Application No. PCT/US2007/004945 filed Feb. 27, 2007, which entered the National Stage in the U.S. as Ser. No. 12/280,894 filed Aug. 27, 2008, and International Application No. PCT/US2007/005095 filed Feb. 27, 2007, which entered the National Stage in the U.S. as Ser. No. 12/280,894 filed Aug. 27, 2008, each of which is incorporated herein by reference in its entirety. The IV fluid exiting the flow sensor 69 then travels through the outlet 110 to an outlet tube coupled to a patient or subject.

When the flow resistor assembly 10 needs to be turned off, the cap 40 can be turned to the off position either manually or electronically under programmed control (e.g., by using a touch screen or other user interface of an electronic control center, not shown, to stop the infusion). The off position is achieved when no portion of the spiral flow path 72 is exposed to the IV fluid at the fluid inlet 22. Since the spiral region 70 contains a region with no fluid flow channel, the disclosed flow resistor 10 does not require mechanical collision to turn off the fluid flow. Rather, the flow resistor 10 contains an off zone or range. Therefore, the flow resistor assembly 10 can be turned off without a mechanical face-to-face collision, such as is required when using needle valves. Thus, the off zone provides a region or range of positions where no fluid can flow through the flow resistor assembly 10 and where a mechanical stop is not required to reach the off condition.

The sealing region 80 of the plunger 60 includes a proximal seal 82 and a distal seal 84. The proximal seal 82 and distal seal 84 are each of the same diameter and when a consistent diameter is coupled with the interior fluid pathway 64, the resistor assembly 10 can be reset to any desired flow rate without causing a pumping effect. Since there is no pumping effect, the fluid is prevented from being pumped into or out of the patient when the resistor is rapidly turned on or shut off, thereby maintaining the desired flow rate. The sealing region 80 also contains one or more anti-rotate protrusions 86, each of which rides in a corresponding, aligned axially extending channel 28 as the plunger 60 translates linearly along the interior axis of the housing 20, thus preventing rotation of the plunger 60 relative to the outer housing 20 as the cap 40 is rotated.

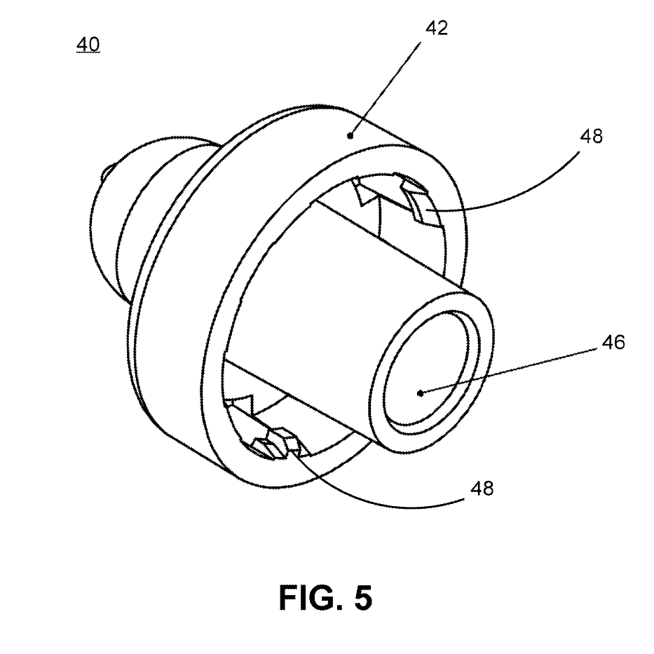

Referring now to FIG. 5, there is shown an exemplary adjustment cap 40 including a cap body 42, an internal helical thread 44 (see FIG. 3), a distal seal 46, and one or more protrusions 48. The interior of the cap body 42 contains the internal helical thread 44, which engages the external helical thread 66 of the plunger 60 enabling the rotational adjustment of the plunger 60. The distal seal 46 provides a fluidic seal between the outer housing 20 and the adjustment cap 40, thereby preventing IV fluid from leaking therebetween. The one or more protrusions 48 secure the cap 40 to the outer housing 20. An O-ring 90 sits between the cap 40 and the outer housing 20 to provide an additional seal for preventing IV fluid from leaking from the flow resistor assembly 10.

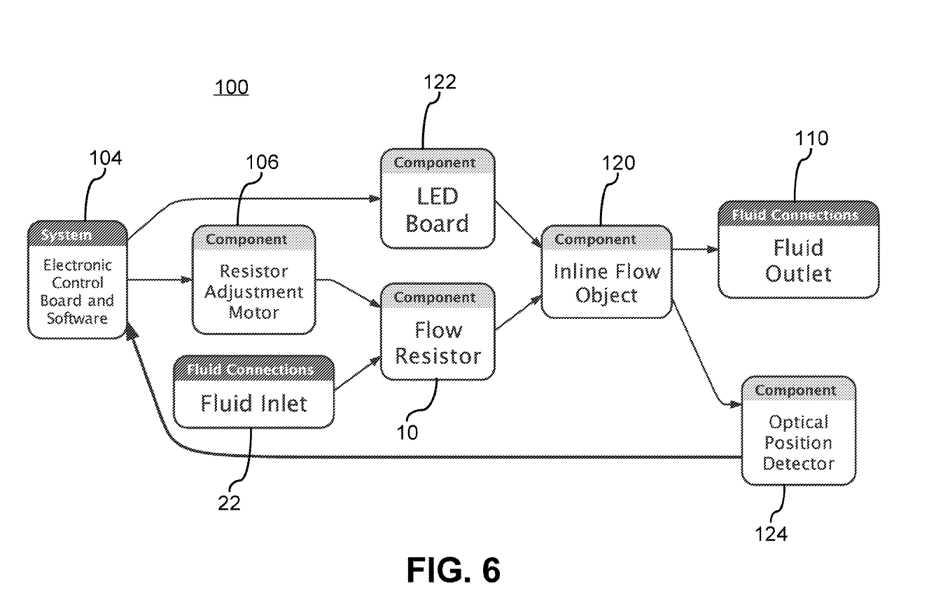

Referring now to FIG. 6, there is outlined a preferred exemplary system 100 for controlling the fluid flow resistor 10 within a sensor based fluid control system. An electronic control board 104 and its software may control the operation of the flow resistor 10 and monitor the conditions within which the flow resistor 10 is operating. An operator, such as a healthcare provider or patient, can either manually input the desired infusion information or input the infusion information using an alternative input means, such as a bar code reader. After the infusion data is input, it is desirable to confirm the infusion data before the infusion can begin. Once the infusion information is confirmed, the electronic control board 104 will determine the proper setting for the flow resistor 10 based on the flow rate and, optionally, other parameters such as fluid viscosity, temperature, and others.

After confirmation of the desired infusion information, the electronic control board 104 will drive operation of the fluid flow resistor 10 under programmed control by sending signals from the electronic control board 104 to a resistor adjustment motor 106, such as a servo motor or the like, coupled to the cap 40. The adjustment motor 106 provides the necessary power to turn the adjustment cap 40 on the flow resistor 10 to control fluid flow in accordance with the input infusion information. The input information may be, for example, a target flow rate, a target volume, a target time for completion of an infusion, and so forth. During infusion of the IV fluid into the patient, the electronic control board 104 can adjust the settings of the flow resistor 10 and the driving pressure to fine-tune the flow rate in accordance with the input infusion information. It will be recognized that the adjustment of the flow resistor 10 herein need not be the sole variable controlling flow rate. For example, a flow control system embodying the flow resistor 10 herein may have additional variables for controlling fluid flow rate, such as an inflatable bladder or other means for varying the fluid driving pressure.

The position of the flow object 120 can be monitored optically to determine the actual flow rate of the IV fluid as it passes out of the flow resistor 10 to the patient. The flow object 120 may be monitored, for example, by an optical sensor, which includes a light source 122 such as an LED array and an optical detector 124, which may be a photosensor array, such as a charged-coupled device (CCD) array or the like. The light source 122 and optical detector 124 are preferably disposed on opposite sides of a flow chamber containing the flow object 120, although other configurations are contemplated, such as an optical detector positioned to sense light emitted by the light source 122 and reflected by the flow object 120. The pattern of light is sensed by the detector 124 to determine the position of flow object 120 within the flow sensor. The position information, in turn, is used to determine an actual fluid flow rate. The flow rate information can be sent to the electronic control board to control fluid flow in accordance with the infusion information. The electronic control module 104 may also be programmed to shut off flow in response to a detected alarm condition such as occlusion, detected an air bubble, etc.

The fluid flow resistor assembly 10 of the present disclosure can be used in conjunction with various flow control systems and optical flow sensors, including those described in the aforementioned International application Nos. PCT/US2007/002039, PCT/US2007/004945, and PCT/US2007/005095.

The invention has been described with reference to the preferred embodiments. Modifications and alterations will occur to others upon a reading and understanding of the preceding detailed description. It is intended that the invention be construed as including all such modifications and alterations insofar as they come within the scope of the appended claims or the equivalents thereof.

Having thus described the preferred embodiments, the invention is now claimed to be:

1. A variable fluid flow resistor, comprising:
a housing having an inlet and an outlet and defining a fluid passageway therebetween;
a plunger slidably received within the fluid passageway;
an actuator rotatably coupled to said housing and said plunger, wherein rotation of said actuator causes sliding movement of said plunger within said fluid passageway;
said plunger having a sealing region and a variable flow region axially adjacent said sealing region, wherein fluid flow through the fluid passageway is prevented when the sealing region is aligned with said inlet and fluid flow through the fluid passageway is permitted when the variable flow region is aligned with said inlet; and
said variable flow region including a helical groove extending from a first end of the variable flow region adjacent said sealing region and away from said sealing region to a second end of the variable flow region, said helical groove cooperating with said housing to define a fluid flow path, wherein a cross-sectional area of said helical groove increases from the first end to the second end.

2. The variable fluid flow resistor of claim 1, wherein said helical groove has one or both of a tapering width and a tapering depth.

3. The variable fluid flow resistor of claim 1, wherein said plunger includes:
a helical groove rotatably engaging a complimentary helical protrusion on said actuator.

4. The variable fluid flow resistor of claim 1, wherein said sealing region includes first and second spaced apart seals defining a fluid containing region therebetween.

5. The variable fluid flow resistor of claim 1, wherein said plunger includes a protrusion received within an axially extending groove for preventing relative rotation between said plunger and said housing.

6. The variable fluid flow resistor of claim 1, wherein said actuator comprises:
a body having one or more protrusions extending inwardly from said body to rotatably connect said body to said outer housing;
a helical thread for rotatably engaging a complimentary helical groove on said plunger; and
a seal for providing a fluidic seal between said outer housing and said actuator.

7. The variable fluid flow resistor of claim 6, wherein said helical thread and rotatably engaged helical groove are configured to permit fluid flow therepast.

8. The variable fluid flow resistor of claim 6, further comprising:
one or more mechanical stops formed on said actuator for limiting a degree of rotation of said actuator.

9. The variable fluid flow resistor of claim 1, wherein said plunger includes an axially extending bore defining a fluid path therethrough.

10. The variable fluid flow resistor of claim 1, wherein fluid flow through said variable fluid flow resistor is prevented over a range of axial positions of said plunger within said housing.

11. A fluid flow control system, comprising:
a variable fluid flow resistor including:
a housing having an inlet and an outlet and defining a fluid passageway therebetween;
a plunger slidably received within the fluid passageway;
an actuator rotatably coupled to said housing and said plunger, wherein rotation of said actuator causes sliding movement of said plunger within said fluid passageway;
said plunger having a sealing region and a variable flow region axially adjacent said sealing region, wherein fluid flow through the fluid passageway is prevented when the sealing region is aligned with said inlet and fluid flow through the fluid passageway is permitted when the variable flow region is aligned with said inlet; and
said variable flow region including a helical groove extending from a first end of the variable flow region adjacent said sealing region and away from said sealing region to a second end of the variable flow region, said helical groove cooperating with said housing to define a fluid flow path, wherein a cross-sectional area of said helical groove increases from the first end to the second end; and
a controller operably coupled to said variable fluid flow resistor for controlling operation of said variable fluid flow resistor.

12. The fluid flow control system of claim 11, further comprising:
a flow sensor for determining a rate of fluid flow in the flow control system.

13. The fluid flow control system of claim 12, wherein said variable fluid flow resistor and said fluid sensor are integrally formed.

14. The fluid flow control system of claim 12, wherein the fluid sensor is an inline flow sensor having:
an inline flow sensor element received within a flow pathway; and
an optical sensor for optically sensing a position of said inline flow sensor element within the flow pathway.

15. The flow control system of claim 12, wherein said controller includes a resistor adjustment motor coupled to said actuator for selectively rotating said actuator relative to said housing.

16. A method for controlling a fluid flow rate using a variable fluid flow resistor, comprising:
connecting a fluid source to a variable fluid flow resistor, said variable flow resistor including:
a housing having an inlet and an outlet and defining a fluid passageway therebetween;
a plunger slidably received within the fluid passageway;
an actuator rotatably coupled to said housing and said plunger, wherein rotation of said actuator causes sliding movement of said plunger within said fluid passageway;
said plunger having a sealing region and a variable flow region axially adjacent said sealing region, wherein fluid flow through the fluid passageway is prevented when the sealing region is aligned with said inlet and fluid flow through the fluid passageway is permitted when the variable flow region is aligned with said inlet; and
said variable flow region including a helical groove extending from a first end of the variable flow region adjacent said sealing region and away from said sealing region to a second end of the variable flow region, said helical groove cooperating with said housing to define a fluid flow path, wherein a cross-sectional area of said helical groove increases from the first end to the second end; and
rotating said actuator of said variable fluid flow resistor to achieve a target flow rate.

17. The method of claim 16, wherein the actuator is rotated manually.

18. The method of claim 16, further comprising:
operably coupling said actuator to a controller for controlling operation of said variable fluid flow resistor;
receiving input representative of a target flow rate; and
rotating said actuator with said controller under preprogrammed control to achieve the target flow rate.

19. The method of claim 16, further comprising:
sensing an actual flow rate;
comparing the actual flow rate to said target flow rate;
if the actual flow rate is less than the target flow rate, rotating the actuator to increase flow rate; and
if the actual flow rate is greater than the target flow rate, rotating the actuator to decrease the flow rate.

20. The method of claim 19, wherein the actual flow rate is sensed using an inline flow sensor including an inline flow sensor element and an optical detector for detecting a position of the inline flow sensor element.
